(19) United States
(12) Patent Application Publication
(10) Pub. No.: US 2011/0194655 A1
(43) Pub. Date: Aug. 11, 2011

(54) METHODS AND APPARATUS TO PERFORM RESIDUAL FREQUENCY OFFSET ESTIMATION AND CORRECTION IN IEEE 802.11 WAVEFORMS

(75) Inventors: Hemanth Sampath, San Diego, CA (US); Sameer Vermani, San Diego, CA (US); Didier Johannes Richard Van Nee, De Meern (NL)

(73) Assignee: QUALCOMM INCORPORATED, San Diego, CA (US)

(21) Appl. No.: 13/023,243

(22) Filed: Feb. 8, 2011

Related U.S. Application Data
(60) Provisional application No. 61/303,197, filed on Feb. 10, 2010.

(51) Int. Cl. H04L 27/06

(52) U.S. Cl. 375/341; 375/344

(57) ABSTRACT

Methods and apparatus are provided for performing and utilizing residual frequency offset estimation and correction in Institute of Electrical and Electronics Engineers (IEEE) 802.11 waveforms. Certain aspects of the present disclosure provide a technique for enabling one to perform good channel estimation with a signal-to-noise ratio (SNR)>33 dB, even in the presence of residual frequency errors. Further, certain aspects may enable one to support uplink Spatial Division Multiple Access (UL-SDMA), even in the presence of residual frequency offsets at the client side.

### CROSS-REFERENCE TO RELATED APPLICATION(S)

This application claims the benefit of U.S. Provisional Patent Application No. 61/303,197 entitled “METHOD TO PERFORM RESIDUAL FREQUENCY OFFSET ESTIMATION AND CORRECTION IN 802.11 WAVEFORMS,” filed on Feb. 10, 2010, which is expressly incorporated by reference herein in its entirety.

### TECHNICAL FIELD

Certain aspects of the present disclosure generally relate to wireless communications and, more particularly, to performing and utilizing residual frequency offset estimation and correction in IEEE 802.11 waveforms.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple Input Multiple Output (MIMO) technology represents one such approach that has recently emerged as a popular technique for next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide a method for wireless communications. The method generally includes receiving a long training field (LTF) of a frame structure, the LTF comprising a first symbol and a second symbol, and a third symbol subsequent to the LTF; determining a frequency offset based on at least one of the first and second symbols; determining one or more phase offsets based, at least in part, on the third symbol; and adjusting the frequency offset based on the one or more phase offsets.

Certain aspects provide an apparatus for wireless communications. The apparatus generally includes a receiver configured to receive an LTF of a frame structure, the LTF comprising a first symbol and a second symbol, and a third symbol subsequent to the LTF; at least one processor; and a memory coupled to the at least one processor. The at least one processor is typically configured to determine a frequency offset based on at least one of the first and second symbols; to determine one or more phase offsets based, at least in part, on the third symbol; and to adjust the frequency offset based on the one or more phase offsets.

Certain aspects provide an apparatus for wireless communications. The apparatus generally includes means for receiving an LTF of a frame structure, the LTF comprising a first symbol and a second symbol, and a third symbol subsequent to the LTF; means for determining a frequency offset based on at least one of the first and second symbols; means for determining one or more phase offsets based, at least in part, on the third symbol; and means for adjusting the frequency offset based on the one or more phase offsets.

Certain aspects provide a computer-program product for wireless communications. The computer-program product generally includes a computer-readable medium having instructions stored thereon, the instructions being executable by one or more processors. The instructions generally include instructions for receiving an LTF of a frame structure, the LTF comprising a first symbol and a second symbol, and a third symbol subsequent to the LTF; instructions for determining a frequency offset based on at least the first and second symbols; instructions for determining one or more phase offsets based, at least in part, on the third symbol; and instructions for adjusting the frequency offset based on the one or more phase offsets.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example frame structure with various fields of a preamble, in accordance with certain aspects of the present disclosure.

FIG. 5 illustrates example operations for performing residual frequency offset estimation and correction in accordance with certain aspects set forth herein.

FIG. 5A illustrates example means capable of performing the operations of FIG. 5.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects. Also as used herein, the term “legacy stations” generally refers to wireless network nodes that support the Institute of Electrical and Electronics Engineers (IEEE) 802.11n or earlier versions of or amendments to the IEEE 802.11 standard.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to a different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

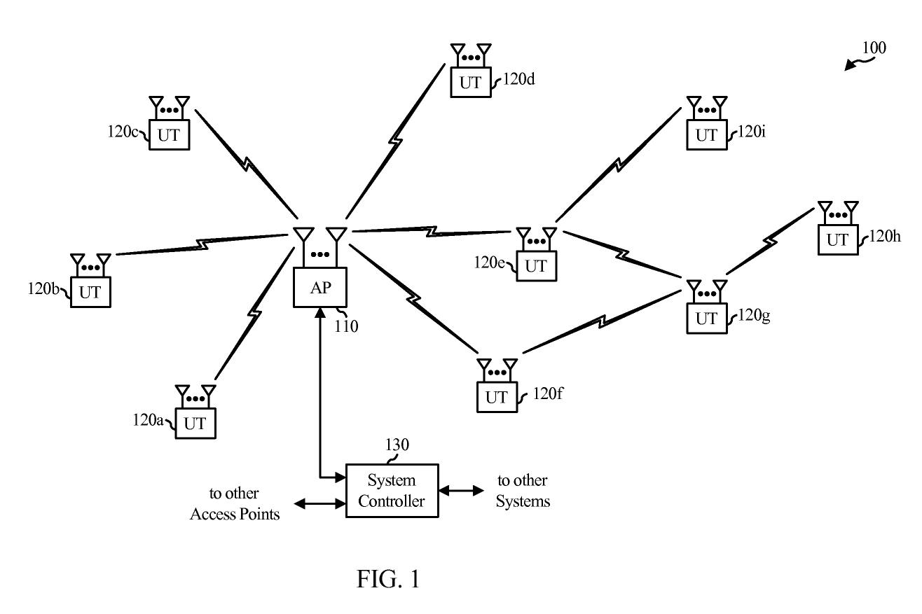

FIG. 1 illustrates a multiple-input multiple-output (MIMO) system 100 with access points and user terminals. For simplicity, only one access point 110 is shown in FIG. 1. An access point (AP) is generally a fixed station that communicates with the user terminals and may also be referred to as a base station or some other terminology. A user terminal may be fixed or mobile and may also be referred to as a mobile station, a station (STA), a client, a wireless device, or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. In certain cases, it may be desirable to have Nₐₚ≧Nᵤ≧1 if the data symbol streams for the Nᵤ user terminals are not multiplexed in code, frequency, or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

MIMO system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported).

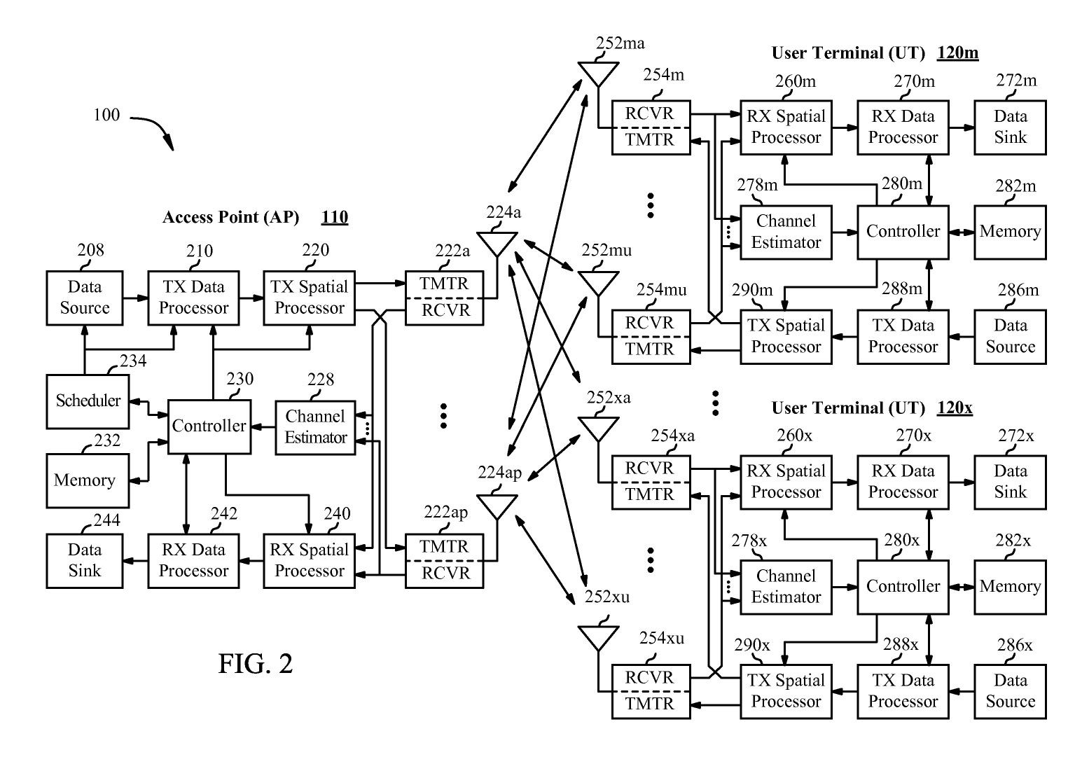

FIG. 2 shows a block diagram of access point 110 and two user terminals 120m and 120x in MIMO system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m}, transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal. The receiver spatial processing is performed in accordance with the CCMI, MMSE, or some other technique. A channel estimator 278 may estimate the wireless channel based on the received symbol stream from the RCVR 254, and the RX spatial processor 260 may use the channel estimate to perform the spatial processing. An RX data processor 270 processes (e.g., demodulates, deinterleaves, and decodes) the recovered downlink data symbol stream to obtain decoded data for the user terminal.

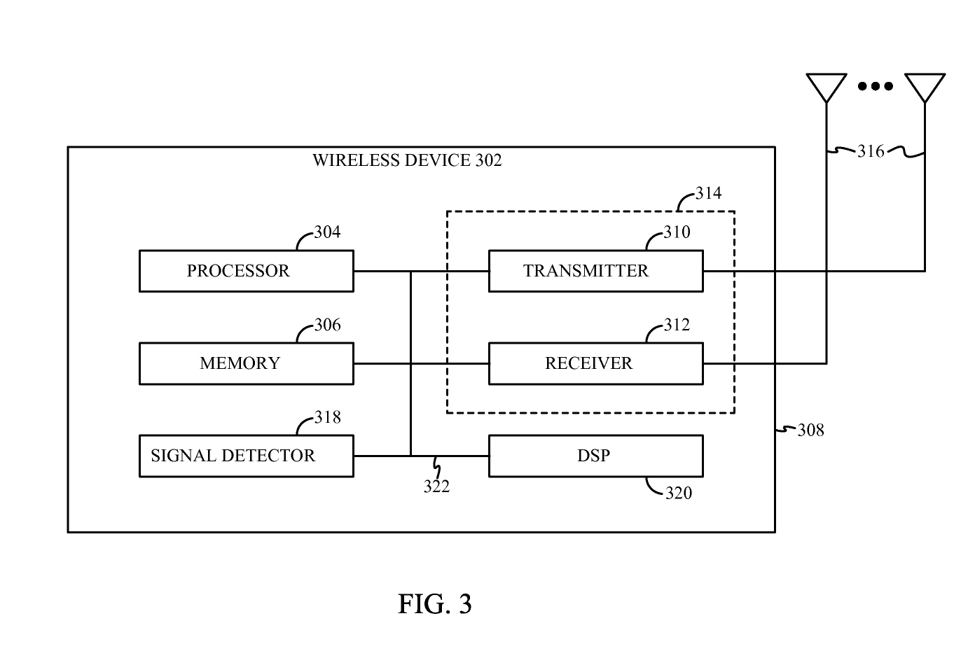

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304, which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Those skilled in the art will recognize the techniques described herein may be generally applied in systems utilizing any type of multiple access schemes (i.e., multi-user protocols), such as SDMA, OFDMA, CDMA, SDMA, and combinations thereof.

### An Example Method to Perform Residual Frequency Offset Estimation and Correction

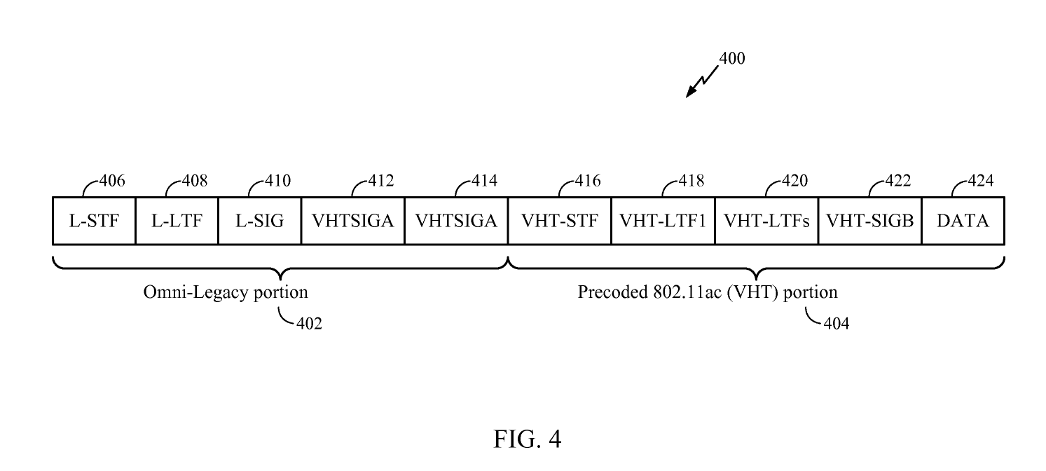

FIG. 4 illustrates an example frame structure with various fields of a preamble 400. The preamble 400 may be in accordance with IEEE 802.11ac or later amendments to the IEEE 802.11 standard. The preamble 400 may be transmitted, for example, from the access point (AP) 110 to the user terminals 120 in the wireless system 100 illustrated in FIG. 1.

The preamble 400 may comprise an omni-legacy portion 402 (i.e., the non-beamformed portion) and a precoded 802.11ac VHT (Very High Throughput) portion 404. The legacy portion 402 may comprise: a Legacy Short Training Field (L-STF) 406, a Legacy Long Training Field (L-LTF) 408, a Legacy Signal (L-SIG) field 410, and two OFDM symbols 412, 414 for VHT Signal A (VHT-SIGA) fields. The L-STF 406 may comprise ten identical symbols of 800 ns each and may be used for coarse carrier frequency offset (CFO) estimation. The L-LTF 408 may comprise two identical symbols and may be used for fine CFO estimation and sampling frequency offset estimation. The VHT-SIGA fields 412, 414 may be transmitted omni-directionally and may indicate allocation of numbers of spatial streams to a combination (set) of STAs.

The precoded 802.11ac VHT portion 404 may comprise a Very High Throughput Short Training Field (VHT-STF) 416, a Very High Throughput Long Training Field 1 (VHT-LTF1) 418, Very High Throughput Long Training Fields (VHT-LTFs) 420, a Very High Throughput Signal B (VHT-SIGB) field 422, and a data portion 424. The VHT-SIGB field 422 may comprise one OFDM symbol and may be transmitted precoded/beamformed. A precoded VHT-SIGB field may contain the MCS and length per user.

The number of VHT-LTF symbols may be equal to the total number of spatial streams for all clients. For 8×8 transmission, this may result in 8 VHT-LTF symbols. Robust MU-MIMO reception may involve the AP transmitting all VHT-LTFs 418, 420 to all supported STAs. The VHT-LTFs 418, 420 may allow each STA to estimate a MIMO channel from all AP antennas to the STA's antennas. The STA may utilize the estimated channel to perform effective interference nulling from MU-MIMO streams corresponding to other STAs. To perform robust interference cancellation, each STA may be expected to know which spatial stream belongs to that STA, and which spatial streams belong to other users.

For unicast transmissions, initial frequency estimate performed by the receiver using the first L-LTF symbol (L-LTF1) has a residual error on the order of 1 kHz. This translates into a channel estimation signal-to-noise ratio (SNR) floor of less than 30 dB for 8 LTFs needed for 8 spatial stream transmissions. This is because residual frequency error causes phase rotation across the LTFs, which destroys orthogonality among received LTFs and, thus, degrades channel estimation quality. Note that the larger the number of LTFs required, the larger is the channel estimation error. Residual frequency error was not deemed a problem in 4×4 IEEE 802.11n since the channel estimation SNR was greater than 30 dB for 4 LTFs, but is a problem for IEEE 802.11ac and later amendments to the 802.11n standard supporting 8 or more spatial stream transmissions.

Accordingly, what is needed are techniques and apparatus to estimate the residual frequency error and/or phase errors across the LTF symbols.

Furthermore, in multiple access transmissions (e.g., UL-SDMA), each client can potentially have a different residual error. Even if each client in an uplink SDMA (UL-SDMA) transmission corrects the transmitted waveform with the DL frequency offset estimate, the net effect of approximately a 1 kHz residual frequency error from each client, may make access point (AP) channel estimation in UL-SDMA transmission close to impossible. This is because an independent residual frequency error from each client causes different phase rotation contributions that destroy orthogonality among received LTFs. This degrades channel estimation SNR to <<30 dB.

Accordingly, what is also needed are techniques and apparatus to estimate the residual frequency error in DL and correct UL transmissions.

According to certain aspects, decoded VHT-SIG-A symbols (assuming the CRC has passed) and/or the decoded signal (L-SIG) symbol (assuming the CRC has passed) may be used as pilots, in addition to L-LTF symbols. Thus, there may be a total of 5 OFDM symbols available that can be used to measure residual frequency offset <200 Hz. This may translate to a channel estimation SNR greater than 33 dB, assuming −41 dBc IPN.

There are several sub-methods that can be employed using the above 5 OFDM symbols. In a first sub-method, L-LTF1 and the second VHT-SIG-A symbol may be used to determine the phase roll between these 2 symbols. The presence of 4 OFDM symbols (T=16 μs) between L-LTF1 and the second VHT-SIGA OFDM symbol allows one to measure the frequency error to a very small granularity. For example, suppose due to modem implementation constraints, such as the size of a look-up table or quantization, a phase granularity of π/512 can be recorded. This results in the ability to measure a minimum frequency error=1/(2*T*256)=125 Hz using T=16 μs (4*4 μs). This is in contrast to using L-LTF1 and L-LTF2, where T=4 μs. This only allows one to measure a minimum frequency error of 600 Hz.

In a second sub-method, all 5 OFDM symbols may be used to obtain a maximum likelihood (ML) detection of residual frequency error. First, define yₖ(n) to be the n^{th} sample of the k^{th} OFDM symbol. Second, compute the following phase rolls θ_{p=1, 2, 3, 4} between the 5 OFDM symbols:

$$\begin{matrix}{θ}_{1} = \frac{{\sum }_{k = 1}^{4} {\sum }_{n = 1}^{N} {y}_{k} ( n ) {y}_{k + 1}^{*} ( n )}{{\sum }_{k = 1}^{4} {\sum }_{n = 1}^{N} {y}_{k} ( n ) {y}_{k}^{*} ( n )} , & Equation 1 \\ {θ}_{2} = \frac{{\sum }_{k = 1}^{3} {\sum }_{n = 1}^{N} {y}_{k} ( n ) {y}_{k + 2}^{*} ( n )}{{\sum }_{k = 1}^{3} {\sum }_{n = 1}^{N} {y}_{k} ( n ) {y}_{k}^{*} ( n )} , & Equation 2 \\ {θ}_{3} = \frac{{\sum }_{k = 1}^{2} {\sum }_{n = 1}^{N} {y}_{k} ( n ) {y}_{k + 3}^{*} ( n )}{{\sum }_{k = 1}^{2} {\sum }_{n = 1}^{N} {y}_{k} ( n ) {y}_{k}^{*} ( n )} , & Equation 3 \\ {θ}_{4} = \frac{{\sum }_{k = 1}^{1} {\sum }_{n = 1}^{N} {y}_{k} ( n ) {y}_{k + 4}^{*} ( n )}{{\sum }_{k = 1}^{1} {\sum }_{n = 1}^{N} {y}_{k} ( n ) {y}_{k}^{*} ( n )} . & Equation 4\end{matrix}$$

Third, define

Y(f)=[e^{j2πfT}e^{j2πf2T}e^{j2πf3T}e^{j2πf4T}] Equation 5,

where T=4 μs and f=residual frequency error.

Fourth, define

θ=[θ₁θ₂θ₃θ₄] Equation 6.

Finally, determine

$${f}^{*} = {argmin}_{j} {‖ Y ( f ) - Θ ‖}^{2} , \qquad Equation 7$$

where argmin (the “argument of the minimum”) is the set of points of the given argument for which the value of the given expression attains its minimum and ∥Y(f)−Θ∥ is the norm of the vector Y(f)−Θ. In this manner, the phase rolls, and hence the residual frequency offset, may be determined using an average constellation phase error of all subcarriers (i.e., the N samples) in Equations 1-4 above.

For DL-SDMA and MIMO transmission, after estimating the initial and residual DL frequency estimate, the correction may be done by applying the frequency offset to the received samples. Next, sampling offset may be corrected by applying a phase slope across the receiver subcarriers and skipping or adding a guard time sample whenever the maximum phase slope exceeds π (180°). Hardware to accomplish the above may be exactly the same as or similar to that employed to correct for carrier and sampling offset in an IEEE 802.11n receiver.

For UL-SDMA transmissions, each client may use the combined DL initial frequency estimate plus residual frequency estimate to correct for UL-SDMA transmitted waveforms. Correction for the carrier frequency offset (CFO) may be done by applying the inverse offset to the transmitted samples. Next, sampling offset may be corrected by applying a phase slope across the transmitted subcarriers and skipping or adding a guard time sample whenever the maximum phase slope exceeds π (180°). Hardware to accomplish the above may be exactly the same as or similar to that employed to correct for carrier and sampling offset in an IEEE 802.11n receiver.

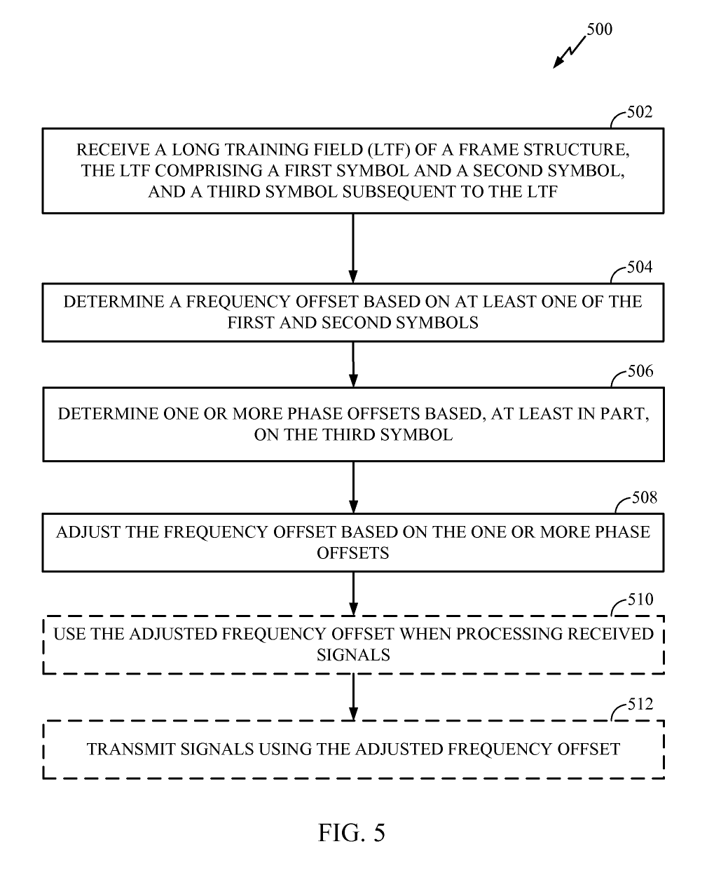

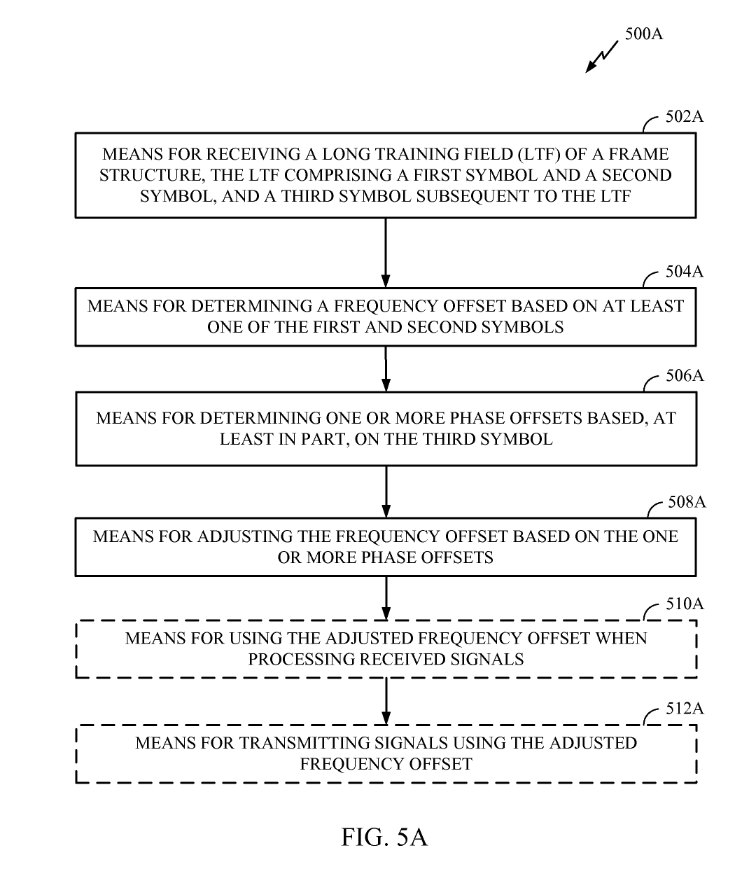

FIG. 5 illustrates example operations 500 that may be performed, for example, by a user terminal 120, for performing residual frequency offset estimation and correction in accordance with certain aspects set forth herein. At 502, the user terminal may receive a long training field (LTF) of a frame structure (e.g., an L-LTF 408 of a preamble 400), the LTF comprising at least a first symbol and a second symbol, and at least a third symbol subsequent to the LTF. For certain aspects, the third symbol may comprise the second VHT-SIGA symbol 414. In this manner, there may be at least 16 μs between the start of the first symbol and the start of the third symbol, which leads to better phase offset granularity and, hence, more accurate residual frequency offset estimations.

At 504, the user terminal may determine a frequency offset (e.g., an initial frequency offset) based on at least one of the first and second symbols. At 506, the user terminal may determine one or more phase offsets based, at least in part, on the third symbol. At 508, the user terminal may adjust the frequency offset based on the one or more phase offsets.

For certain aspects, the user terminal may use the adjusted frequency offset when processing received signals at 510. At 512, the user terminal may optionally transmit signals using the adjusted frequency offset for certain aspects.

Certain aspects of the present disclosure may allow one to perform good channel estimation with SNR>33 dB, even in the presence of residual frequency errors. Further, certain aspects may enable one to support UL-SDMA, even in the presence of residual frequency offsets at the client side.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the Figures, those operations may have corresponding counterpart means-plus-function components with similar numbering. For example, operations 500 illustrated in FIG. 5 correspond to means 500A illustrated in FIG. 5A.

As example means, the means for transmitting may comprise a transceiver or transmitter, such as the transmitter unit 254 of the user terminal 120 illustrated in FIG. 2. The means for receiving may comprise a transceiver or a receiver, such as the receiver unit 254 of the user terminal 120 depicted in FIG. 2. The means for determining, means for processing, means for adjusting, or means for using may comprise a processing system, which may include one or more processors, such as the RX data processor 270, the channel estimator 278, and/or the controller 280 of the user terminal illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
receiving a long training field (LTF) of a frame structure, the LTF comprising a first symbol and a second symbol, and a third symbol subsequent to the LTF;
determining a frequency offset based on at least one of the first and second symbols;
determining one or more phase offsets based, at least in part, on the third symbol; and
adjusting the frequency offset based on the one or more phase offsets.

2. The method of claim 1, wherein determining the one or more phase offsets comprises determining at least one phase offset based on at least the third, a fourth, and a fifth symbol subsequent to the LTF.

3. The method of claim 2, wherein the third symbol comprises a Legacy Signal (L-SIG) symbol and the fourth and fifth symbols comprise Very High Throughput Signal A (VHT-SIGA) symbols.

4. The method of claim 2, wherein determining the one or more phase offsets comprises using a maximum likelihood (ML) detection based on the first through fifth symbols.

5. The method of claim 1, further comprising transmitting signals using the adjusted frequency offset.

6. The method of claim 5, wherein using the adjusted frequency offset comprises applying an inverse of the adjusted frequency offset to samples of the signals to be transmitted.

7. The method of claim 5, wherein transmitting the signals comprises transmitting the signals using a multi-user protocol.

8. The method of claim 7, wherein the multi-user protocol comprises at least one of spatial division multiple access (SDMA) or orthogonal frequency division multiple access (OFDMA).

9. The method of claim 1, further comprising using the adjusted frequency offset when processing received signals.

10. The method of claim 9, wherein the received signals are transmitted using a multi-user protocol.

11. The method of claim 10, wherein the multi-user protocol comprises at least one of spatial division multiple access (SDMA) or orthogonal frequency division multiple access (OFDMA).

12. The method of claim 1, wherein the third symbol comprises a Very High Throughput Signal A (VHT-SIGA) symbol.

13. The method of claim 1, wherein determining the one or more phase offsets comprises determining the one or more phase offsets based on the first symbol and the third symbol and wherein there are at least 16 μs between a start of the first symbol and a start of the third symbol.

14. The method of claim 1, wherein determining the one or more phase offsets comprises determining the one or more phase offsets using an average constellation phase error of all subcarriers.

15. An apparatus for wireless communications, comprising:
a receiver configured to receive a long training field (LTF) of a frame structure, the LTF comprising a first symbol and a second symbol, and a third symbol subsequent to the LTF;
at least one processor configured to:
determine a frequency offset based on at least one of the first and second symbols;
determine one or more phase offsets based, at least in part, on the third symbol; and
adjust the frequency offset based on the one or more phase offsets; and
memory coupled to the at least one processor.

16. The apparatus of claim 15, wherein the at least one processor is configured to determine the one or more phase offsets by determining at least one phase offset based on at least the third, a fourth, and a fifth symbol subsequent to the LTF.

17. The apparatus of claim 16, wherein the third symbol comprises a Legacy Signal (L-SIG) symbol and the fourth and fifth symbols comprise Very High Throughput Signal A (VHT-SIGA) symbols.

18. The apparatus of claim 16, wherein the at least one processor is configured to determine the one or more phase offsets by using a maximum likelihood (ML) detection based on the first through fifth symbols.

19. The apparatus of claim 15, further comprising a transmitter configured to transmit signals using the adjusted frequency offset.

20. The apparatus of claim 19, wherein the at least one processor is configured to applying an inverse of the adjusted frequency offset to samples of the signals to be transmitted.

21. The apparatus of claim 19, wherein the transmitter is configured to transmit the signals using a multi-user protocol.

22. The apparatus of claim 21, wherein the multi-user protocol comprises at least one of spatial division multiple access (SDMA) or orthogonal frequency division multiple access (OFDMA).

23. The apparatus of claim 15, wherein the at least one processor is configured to use the adjusted frequency offset when processing received signals.

24. The apparatus of claim 23, wherein the received signals are transmitted using a multi-user protocol.

25. The apparatus of claim 24, wherein the multi-user protocol comprises at least one of spatial division multiple access (SDMA) or orthogonal frequency division multiple access (OFDMA).

26. The apparatus of claim 15, wherein the third symbol comprises a Very High Throughput Signal A (VHT-SIGA) symbol.

27. The apparatus of claim 15, wherein the at least one processor is configured to determine the one or more phase offsets by determining the one or more phase offsets based on the first symbol and the third symbol and wherein there are at least 16 μs between a start of the first symbol and a start of the third symbol.

28. The apparatus of claim 15, wherein the at least one processor is configured to determine the one or more phase offsets by using an average constellation phase error of all subcarriers.

29. An apparatus for wireless communications, comprising:
means for receiving a long training field (LTF) of a frame structure, the LTF comprising a first symbol and a second symbol, and a third symbol subsequent to the LTF;
means for determining a frequency offset based on at least one of the first and second symbols;
means for determining one or more phase offsets based, at least in part, on the third symbol; and
means for adjusting the frequency offset based on the one or more phase offsets.

30. The apparatus of claim 29, wherein the means for determining the one or more phase offsets is configured to determine at least one phase offset based on at least the third, a fourth, and a fifth symbol subsequent to the LTF.

31. The apparatus of claim 30, wherein the third symbol comprises a Legacy Signal (L-SIG) symbol and the fourth and fifth symbols comprise Very High Throughput Signal A (VHT-SIGA) symbols.

32. The apparatus of claim 30, wherein the means for determining the one or more phase offsets is configured to determine the one or more phase offsets by using a maximum likelihood (ML) detection based on the first through fifth symbols.

33. The apparatus of claim 29, further comprising means for transmitting signals using the adjusted frequency offset.

34. The apparatus of claim 33, further comprising means for applying an inverse of the adjusted frequency offset to samples of the signals to be transmitted.

35. The apparatus of claim 33, wherein the means for transmitting is configured to transmit the signals using a multi-user protocol.

36. The apparatus of claim 35, wherein the multi-user protocol comprises at least one of spatial division multiple access (SDMA) or orthogonal frequency division multiple access (OFDMA).

37. The apparatus of claim 29, further comprising means for using the adjusted frequency offset when processing received signals.

38. The apparatus of claim 37, wherein the received signals are transmitted using a multi-user protocol.

39. The apparatus of claim 38, wherein the multi-user protocol comprises at least one of spatial division multiple access (SDMA) or orthogonal frequency division multiple access (OFDMA).

40. The apparatus of claim 29, wherein the third symbol comprises a Very High Throughput Signal A (VHT-SIGA) symbol.

41. The apparatus of claim 29, wherein the means for determining the one or more phase offsets is configured to determine the one or more phase offsets based on the first symbol and the third symbol and wherein there are at least 16 μs between a start of the first symbol and a start of the third symbol.

42. The apparatus of claim 29, wherein the means for determining the one or more phase offsets comprises means for determining the one or more phase offsets using an average constellation phase error of all subcarriers.

43. A computer-program product for wireless communications, comprising a computer-readable medium having instructions stored thereon, the instructions being executable by one or more processors and the instructions comprising:
instructions for receiving a long training field (LTF) of a frame structure, the LTF comprising a first symbol and a second symbol, and a third symbol subsequent to the LTF;
instructions for determining a frequency offset based on at least one of the first and second symbols;
instructions for determining one or more phase offsets based, at least in part, on the third symbol; and
instructions for adjusting the frequency offset based on the one or more phase offsets.

44. The computer-program product of claim 43, wherein the instructions for determining the one or more phase offsets comprise instructions for determining at least one phase offset based on at least the third, a fourth, and a fifth symbol subsequent to the LTF.

45. The computer-program product of claim 44, wherein the third symbol comprises a Legacy Signal (L-SIG) symbol and the fourth and fifth symbols comprise Very High Throughput Signal A (VHT-SIGA) symbols.

46. The computer-program product of claim 44, wherein the instructions for determining the one or more phase offsets comprise instructions for using a maximum likelihood (ML) detection based on the first through fifth symbols.

47. The computer-program product of claim 43, further comprising instructions for transmitting signals using the adjusted frequency offset.

48. The computer-program product of claim 47, wherein using the adjusted frequency offset comprises applying an inverse of the adjusted frequency offset to samples of the signals to be transmitted.

49. The computer-program product of claim 47, wherein the instructions for transmitting the signals comprise instructions for transmitting the signals using a multi-user protocol.

50. The computer-program product of claim 49, wherein the multi-user protocol comprises at least one of spatial division multiple access (SDMA) or orthogonal frequency division multiple access (OFDMA).

51. The computer-program product of claim 43, further comprising instructions for using the adjusted frequency offset when processing received signals.

52. The computer-program product of claim 51, wherein the received signals are transmitted using a multi-user protocol.

53. The computer-program product of claim 52, wherein the multi-user protocol comprises at least one of spatial division multiple access (SDMA) or orthogonal frequency division multiple access (OFDMA).

54. The computer-program product of claim 43, wherein the third symbol comprises a Very High Throughput Signal A (VHT-SIGA) symbol.

55. The computer-program product of claim 43, wherein the instructions for determining the one or more phase offsets comprise instructions for determining the one or more phase offsets based on the first symbol and the third symbol and wherein there are at least 16 μs between a start of the first symbol and a start of the third symbol.

56. The computer-program product of claim 43, wherein the instructions for determining the one or more phase offsets comprise instructions for determining the one or more phase offsets using an average constellation phase error of all subcarriers.
